(19) United States
(12) Patent Application Publication
(10) Pub. No.: US 2026/0228303 A1
(43) Pub. Date: Aug. 6, 2026

(54) ADJUSTING LOGGING LEVELS IN A HYBRID APPLICATION

(71) Applicant: INTERNATIONAL BUSINESS MACHINES CORPORATION, ARMONK, NY (US)

(72) Inventors: William Duncan Hadden, Greenisland (GB); Francis McNamee, Newry (GB)

(21) Appl. No.: 19/044,576

(22) Filed: Feb. 3, 2025

(51) Int. Cl. G06F 17/40

(52) U.S. Cl. CPC G06F 17/40

(57) ABSTRACT

The present disclosure discloses dynamically adjusting logging levels in a hybrid application based on system metrics to enhance diagnostic capabilities and performance. By monitoring metrics in, mapping the metrics to logs using predefined labels, and detecting when the metrics exceed predefined thresholds, logging levels of the logs can be increased dynamically, capturing detailed diagnostic information. Responsive to the metrics returning to a normal range, the verbosity of the logs is reduced.

### BACKGROUND

### Technical Field

The present disclosure relates generally to adjusting logging levels in a hybrid application.

### Description of the Related Art

Most hybrid applications typically generate logs during production. Logs record events, messages, or activities and are generated by a system or application. Logs can be used for troubleshooting to diagnose or resolve application issues. Logs can also be used to track the health of an application or to identify bottlenecks and optimize system performance.

Generally, logs capture various aspects of the operations of an application or system including operations, errors, user interactions and configuration changes. By embedding logging into code, users can get a summary of how an application or system is functioning and be able to see when a problem has occurred.

### SUMMARY

According to an illustrative embodiment, a method comprises adjusting logging levels in a hybrid application by generating, one or more system metrics associated with a plurality of distributed services in an application and mapping each system metric of the one or more system metrics to one or more logs based a predefined label. The method includes detecting that a system metric of the one or more system metrics has exceeded a predefined threshold and increasing, in a first mode of operation, a logging level of the one or more logs associated with the detected system metric. Upon the detected system metric no longer exceeding the predefined threshold the logging level is decreased, in a second mode of operation.

In one embodiment, an agent receives the one or more logs for further processing. The agent is an agent of any distributed service of the plurality of distributed services that has the one or more logs associated with the system metric.

In one embodiment, the method includes configuring the agent to store a plurality of logging information that cover a predefined period of time in the past relative to a current time.

According to an embodiment of the present disclosure, a computing device includes a processor and a memory with computer program instructions that, when executed, when executed by the processor, cause the computing device to perform operations that include generating, one or more system metrics associated with a plurality of distributed services in an application and mapping each system metric of the one or more system metrics to one or more logs based on a predefined label. The operations further include detecting that a system metric of the one or more system metrics has exceeded a predefined threshold and increasing, in a first mode of operation, a logging level of the one or more logs associated with the detected system metric. The operations also include decreasing, in a second mode of operation, the logging level of the one or more logs associated with the detected system metric responsive to the detected system metric no longer exceeding the predefined threshold.

According to an embodiment of the present disclosure, a computer program product includes one or more computer-readable storage devices and program instructions stored on the at least one of the one or more computer-readable storage devices, the program instructions executable by a processor, the program instructions including, comprising program instructions to generate, one or more system metrics associated with a plurality of distributed services in an application. The program instructions also include program instructions to map each system metric of the one or more system metrics to one or more logs based a predefined label and program instructions to detect that a system metric of the one or more system metrics has exceeded a predefined threshold. The program instructions further include program instructions to increase, in a first mode of operation, a logging level of the one or more logs associated with the detected system metric, and program instructions to decrease, in a second mode of operation, the logging level of the one or more logs associated with the detected system metric responsive to the detected system metric no longer exceeding the predefined threshold.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 depicts a block diagram of a network of data processing systems in which illustrative embodiments may be implemented.

FIG. 2 depicts a block diagram of a computing environment in accordance with an illustrative embodiment.

FIG. 3 depicts an architecture for monitoring distributed services within a hybrid application according to an illustrative embodiment.

FIG. 4 depicts a diagram illustrating an association between metrics and the logs associated with services according to an illustrative embodiment.

FIG. 5 depicts a diagram illustrating an association between metrics and the logs associated with services according to an illustrative embodiment.

FIG. 6 depicts an architecture for monitoring distributed services including an in-memory caching mechanism within agents according to an illustrative embodiment.

FIG. 7 depicts a routine for adjusting logging according to an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to dynamically adjusting the logging levels of distributed services in response to changes in a system’s metrics. The distributed services may in some cases operate across multiple computers or devices, dividing tasks across different nodes, and working together to deliver a unified service or functionality Conventional applications typically output rudimentary operational logs in production. Due to the rudimentary nature of the logs, it usually challenging to determine the root cause of issues when an application failure arise. More specifically, when trying to debug the failure of an application or system, it is usually too late to obtain valuable insights into the cause of the failure by the time it is known that a failure has occurred. The lateness is usually due to logs showing symptoms or effects of a failure rather that the cause of the failure. Moreover, storing detailed logs at all times in anticipation of a failure event risks having large storage costs and an impact on system performance.

The illustrative embodiments disclose monitoring system metrics across different landing zones or computing environments wherein responsive to a system metric exceeding a threshold, the level of detail of logs associated with the system metric is adjusted. Dynamically adjusting logging levels in response to system metrics may ensures valuable logging information is available on the occasions when an incident occurs while simultaneously minimizing storage and performance costs at all other times.

Certain operations are described as occurring at a certain component or location in an embodiment. Such locality of operations is not intended to be limiting on the illustrative embodiments. Any operation described herein as occurring at or performed by a particular component, can be implemented in such a manner that one component-specific function causes an operation to occur or be performed at another component, e.g., at a local or remote engine respectively.

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, the method described herein, is implemented to execute on a particularly configured computing device or data processing system and provides substantial advancement of the functionality of that computing device or data processing system by enabling the use dynamic adjustment of logging levels to control the detail of logs in a data processing environment. Embodiments thus have the capacity to improve the technical field of clusters and the management of hybrid cloud environments by making the analysis of root causes simpler while enabling retroactive root cause analysis which has hitherto been unavailable.

Further, one or more of the methodologies discussed herein may obviate a need for resource intensive data processing by the user due to the storage of rolling cache of logs. This may have the technical effect of reducing computing resources used by one or more devices within the system. Examples of such computing resources include, without limitation, processor cycles, network traffic, memory usage, storage space, and power consumption. It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

The illustrative embodiments are described with respect to certain types of data, functions, algorithms, model configurations, locations of embodiments, additional data, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

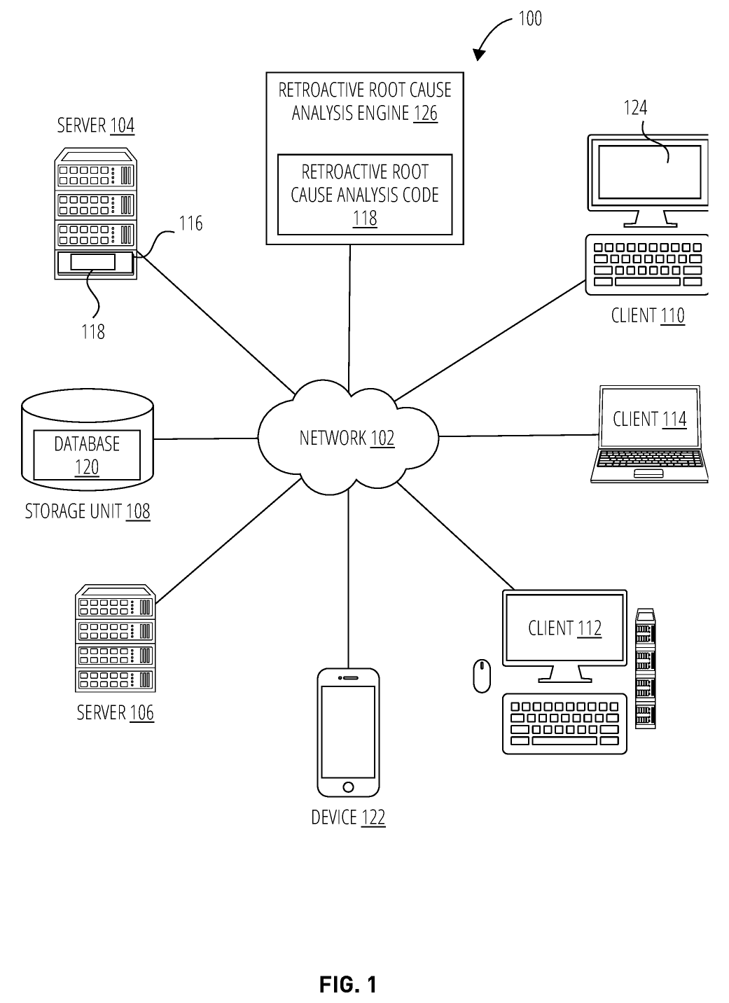

With reference to the figures and in particular with reference to FIG. 1 these figures are example diagrams of data processing environments in which illustrative embodiments may be implemented. FIG. 1 is only an example and is not intended to assert or imply any limitation with regard to the environments in which different embodiments may be implemented. A particular implementation may make many modifications to the depicted environments based on the following description.

### Data Processing Environment

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as clients (client 110, client 112, client 114), retroactive root cause analysis engine 126, and device 122, may include data and may have software applications or software tools executing thereon. Server 104 and server 106 may include one or more GPUs (graphics processing units) for statistical analysis or machine learning.

Only as an example, and without implying any limitation to such architecture, FIG. 1 depicts certain components that are usable in an example implementation of an embodiment. For example, servers and clients are only examples and do not imply a limitation to a client-server architecture. As another example, an embodiment can be distributed across several data processing systems and a data network as shown, whereas another embodiment can be implemented on a single data processing system, which are all within the scope of the illustrative embodiments.

Data processing systems (retroactive root cause analysis engine 126, server 104, server 106, client 110, client 112, client 114, and device 122) also represent example nodes in a cluster, partitions, and other configurations suitable for implementing an embodiment.

Server 104, server 106, storage unit 108, client 110, client 112, client 114, device 122, retroactive root cause analysis engine 126 may couple to network 102 using wired connections, wireless communication protocols, or other suitable data connectivity. Client 110, client 112 and client 114 may be, for example, personal computers or network computers.

In the depicted example, the servers may provide data, such as boot files, operating system images, and applications to client 110, client 112, and client 114. Client 110, client 112 and client 114 may be clients to servers in this example. Client 110, client 112 and client 114 or some combination thereof, may include their own data, boot files, operating system images, and applications. Data processing environment 100 may include additional servers, clients, and other devices that are not shown. Server 104 may include a server application 116 that may be configured to implement one or more of the functions described herein in accordance with one or more embodiments. Server application 116, client application 124 and/or retroactive root cause analysis engine 126 may include retroactive root cause analysis code 118, configured for dynamically adjusting logging levels for retroactive root cause analysis. In some embodiments, retroactive root cause analysis engine 126 may be or form a part of a server or client described herein.

Device 122 is an example of a device described herein. For example, device 122 can take the form of a smartphone, a tablet computer, a laptop computer, client 110 in a stationary or a portable form, or any other suitable device. Any software application described as executing in another data processing system in FIG. 1 can be configured to execute in device 122 in a similar manner. Any data or information stored or produced in another data processing system in FIG. 1 can be configured to be stored or produced in device 122 in a similar manner. Database 120 of storage unit 108 may store one or more term data samples for computations herein.

The data processing environment 100 may also be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud and employ a cloud computing model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200 includes an example of an environment for the execution of at least some of the computer code involved in performing the inventive methods, such as retroactive root cause analysis code 118. In addition to retroactive root cause analysis code 118, computing environment 200 includes, for example, Computer 202, wide area network 228 (WAN), end user device 230 (EUD), remote server 232, public cloud 240, and private cloud 236. In this embodiment, Computer 202 includes processor set 204 (including processing circuitry 206 and cache 208), communication fabric 210, volatile memory 212, persistent storage 214 (including operating system 216 and retroactive root cause analysis code 118, as identified above), peripheral device set 218 (including user interface (UI) device set 220, storage 222, and Internet of Things (IoT) sensor set 224), and network module 226. Remote server 232 includes remote database 234. Public cloud 240 includes gateway 238, cloud orchestration module 242, host physical machine set 246, virtual machine set 244, and container set 248.

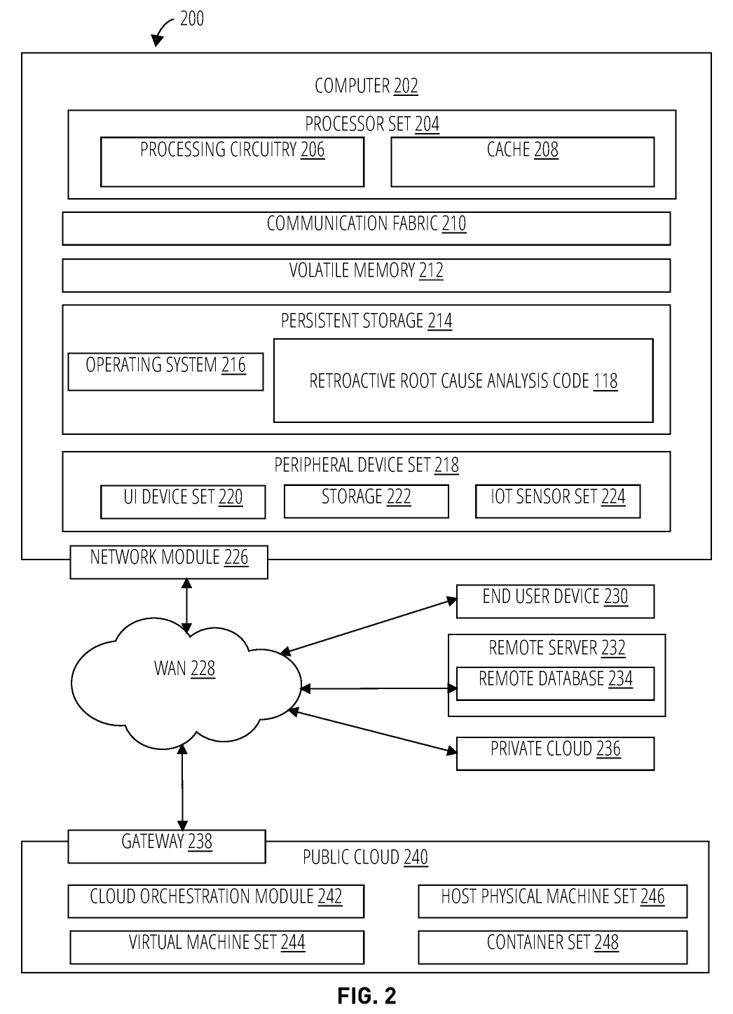

Computer 202 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 234. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically Computer 202, to keep the presentation as simple as possible. Computer 202 may be located in a cloud, even though it is not shown in a cloud in FIG. 2. On the other hand, Computer 202 is not required to be in a cloud except to any extent as may be affirmatively indicated.

Processor set 204 includes one, or more, computer processors of any type now known or to be developed in the future. Processing circuitry 206 may be distributed over multiple packages, for example, multiple, coordinated integrated circuit chips. Processing circuitry 206 may implement multiple processor threads and/or multiple processor cores. Cache 208 is memory that is located in the processor chip package(s) and is typically used for data or code that should be available for rapid access by the threads or cores running on processor set 204. Cache memories are typically organized into multiple levels depending upon relative proximity to the processing circuitry. Alternatively, some, or all, of the cache for the processor set may be located “off chip.” In some computing environments, processor set 204 may be designed for working with qubits and performing quantum computing.

Computer readable program instructions are typically loaded onto Computer 202 to cause a series of operational steps to be performed by processor set 204 of Computer 202 and thereby effect a computer- implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 204 to control and direct performance of the inventive methods. In computing environment 200, at least some of the instructions for performing the inventive methods may be stored in retroactive root cause analysis code 118 in persistent storage 214.

Communication fabric 210 is the signal conduction path that allows the various components of Computer 202 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, volatile memory 212 is characterized by random access, but this is not required unless affirmatively indicated. In Computer 202, the volatile memory 212 is located in a single package and is internal to Computer 202, but, alternatively or additionally, the volatile memory may be distributed over multiple packages and/or located externally with respect to Computer 202.

Persistent storage 214 is any form of non-volatile storage for computers that is now known or to be developed in the future. The non-volatility of this storage means that the stored data is maintained regardless of whether power is being supplied to Computer 202 and/or directly to persistent storage 214. Persistent storage 214may be a read only memory (ROM), but typically at least a portion of the persistent storage allows writing of data, deletion of data and re-writing of data. Some familiar forms of persistent storage include magnetic disks and solid-state storage devices. Operating system 216 may take several forms, such as various known proprietary operating systems or open-source Portable Operating System Interface-type operating systems that employ a kernel. The code included in retroactive root cause analysis code 118 typically includes at least some of the computer code involved in performing the inventive methods.

Peripheral device set 218 includes the set of peripheral devices of Computer 202. Data communication connections between the peripheral devices and the other components of Computer 202 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 220 may include components such as a display screen, speaker, microphone, wearable devices (such as goggles and smart watches), keyboard, mouse, printer, touchpad, game controllers, and haptic devices. Storage 222 is external storage, such as an external hard drive, or insertable storage, such as an SD card. Storage 222 may be persistent and/or volatile. In some embodiments, storage 222 may take the form of a quantum computing storage device for storing data in the form of qubits. In embodiments where Computer 202 is required to have a large amount of storage (for example, where Computer 202 locally stores and manages a large database) then this storage may be provided by peripheral storage devices designed for storing very large amounts of data, such as a storage area network (SAN) that is shared by multiple, geographically distributed computers. IoT sensor set 224 is made up of sensors that can be used in Internet of Things applications. For example, one sensor may be a thermometer, and another sensor may be a motion detector.

Network module 226 is the collection of computer software, hardware, and firmware that allows Computer 202 to communicate with other computers through WAN 228. Network module 226 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 226 are performed on the same physical hardware device. In other embodiments (for example, embodiments that utilize software-defined networking (SDN)), the control functions and the forwarding functions of network module 226 are performed on physically separate devices, such that the control functions manage several different network hardware devices. Computer readable program instructions for performing the inventive methods can typically be downloaded to Computer 202 from an external computer or external storage device through a network adapter card or network interface included in network module 226.

WAN 228 is any wide area network (for example, the internet) capable of communicating computer data over non-local distances by any technology for communicating computer data, now known or to be developed in the future. In some embodiments, the WAN 228 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 230 is any computer system that is used and controlled by an end user (for example, a customer of an enterprise that operates Computer 202) and may take any of the forms discussed above in connection with Computer 202. EUD 230 typically receives helpful and useful data from the operations of Computer 202. For example, in a hypothetical case where Computer 202 is designed to provide a recommendation to an end user, this recommendation would typically be communicated from network module 226 of Computer 202 through WAN 228 to EUD 230. In this way, EUD 230 can display, or otherwise present, the recommendation to an end user. In some embodiments, EUD 230 may be a client device, such as thin client, heavy client, mainframe computer, desktop computer and so on.

Remote server 232 is any computer system that serves at least some data and/or functionality to Computer 202. Remote server 232 may be controlled and used by the same entity that operates Computer 202. Remote server 232 represents the machine(s) that collect and store helpful and useful data for use by other computers, such as Computer 202. For example, in a hypothetical case where Computer 202 is designed and programmed to provide a recommendation based on historical data, then this historical data may be provided to Computer 202 from remote database 234 of remote server 232.

Public cloud 240 is any computer system available for use by multiple entities that provides on- demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 240 is performed by the computer hardware and/or software of cloud orchestration module 242. The computing resources provided by public cloud 240 are typically implemented by virtual computing environments that run on various computers making up the computers of host physical machine set 246, which is the universe of physical computers in and/or available to public cloud 240. The virtual computing environments (VCEs) typically take the form of virtual machines from virtual machine set 244 and/or containers from container set 248. It is understood that these VCEs may be stored as images and may be transferred among and between the various physical machine hosts, either as images or after instantiation of the VCE. Cloud orchestration module 242 manages the transfer and storage of images, deploys new instantiations of VCEs and manages active instantiations of VCE deployments. Gateway 238 is the collection of computer software, hardware, and firmware that allows public cloud 240 to communicate through WAN 228.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 236 is similar to public cloud 240, except that the computing resources are only available for use by a single enterprise. While private cloud 236 is depicted as being in communication with WAN 228, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 240 and private cloud 236 are both part of a larger hybrid cloud.

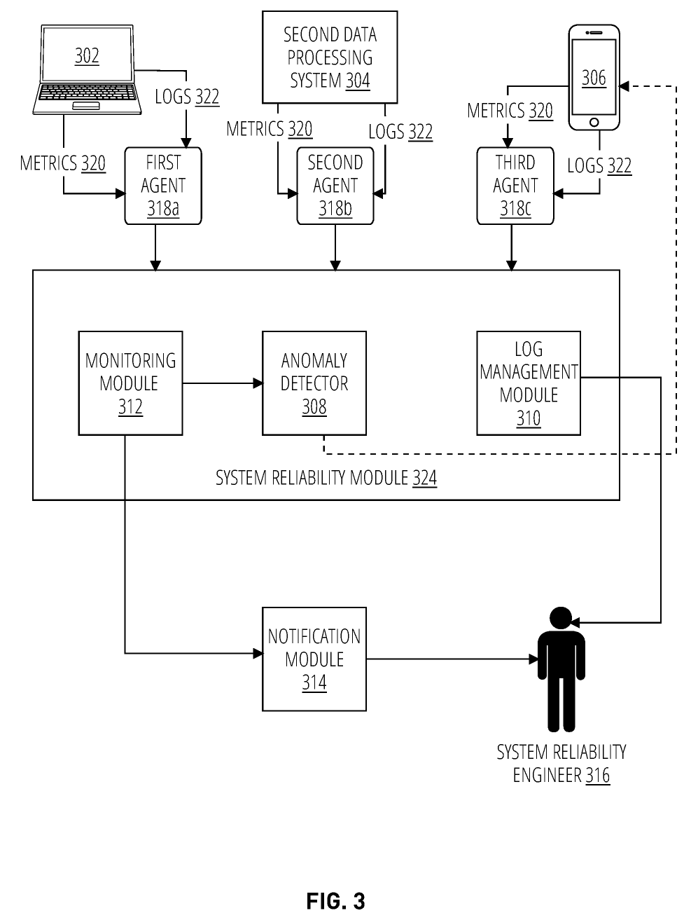

FIG. 3 illustrates an architecture of a system for monitoring distributed services in a hybrid application according to an illustrative embodiment. The diagram demonstrates how metrics and logs are collected, processed, and utilized for system reliability.

First data processing system 302, second data processing system 304, and third data processing system 306 may be devices or systems such as personal computers, clusters, and mobile computing devices respectively. Of course, these are examples and are not meant to be limiting. Data processing systems 302, 304, and 306 may output metrics 320 (also referred to herein as system metrics) and logs 322 related to the services running on the data processing systems. In an embodiment, metrics 320 may provide information related to the operational status of services (for example, connected databases or time for database connections), while logs capture detailed records of specific events and activities. The metrics 320 and the logs 322 may form the foundation for monitoring and diagnosing application issues.

As shown in FIG. 3, a system reliability module 324 configured to optimize system reliability, scalability, and operational efficiency by monitoring performance and managing failure incidents. The system reliability module 324 includes a monitoring module 312, an anomaly detector 308, and a log management module 310 which work together to process the metrics 320 and logs 322 received from (or transmitted by) the data processing systems 302, 304, 306. In some cases, the transmission is performed by agents (e.g., 318a to 318c) of the data processing systems 320, 304, 306.

The monitoring module 312 may be configured to collect, aggregate, and analyze the metrics generated by the services. The monitoring module 312 continuously monitors the metrics, in some cases aided by the agent (e.g., 318a) to detect any anomalies or deviations of the metrics from predefined thresholds. The anomaly detector 308 may be configured to make a determination about the occurrence of an anomaly based on information about the metrics 320 or logs 322 received from the monitoring module 312 which receives the information from the agents 318a, 318b, 318c (collectively 318), and to dynamically adjust the logging levels of just the service associated with the anomaly without affecting other services. In some cases, the anomaly detector 308 may alternatively control the agents 318 for automatic adjustment of logging levels. Each service or application may have an associated agent 318. For example, the first data processing system 302 have a first agent 318a, the second data processing system 304 may have a second agent 318b, and the third data processing system 306 may have a third agent 318c. When a metric meets a threshold criteria, the anomaly detector 308 may increase the detail level of logs 322 for the affected services, ensuring comprehensive information is captured for troubleshooting.

The log management module 310 may be configured to index, store, and visualize the logs. This setup of the log management module 310 may allow for quick retrieval and analysis of logs, enabling Site Reliability Engineers (SREs) 316 to be notified of issues. In some cases, notification module 314 may also be used to notify site reliability engineers 316 directly upon receipt of logs 322 and metrics 320 by the monitoring module 312. More specifically, the notification module may act as an alerting system, wherein when the monitoring module 312 receives a metric exceeding its threshold, an alert may be sent to the notification module 314, which notifies the site reliability engineer 316 in real time, as the anomaly detector simultaneously detects whether any actions should be performed. FIG. 3 is not meant to be limiting as other examples systems may be obtained in view of the descriptions herein without departing from the substance of the disclosure. For example, other systems may include multiple instances of each type of data processing environments and data processing systems.

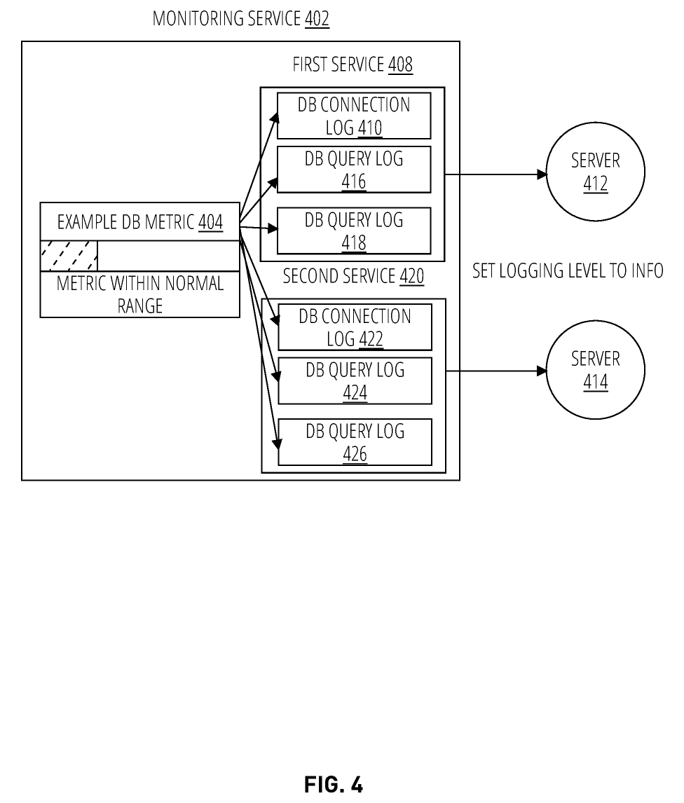

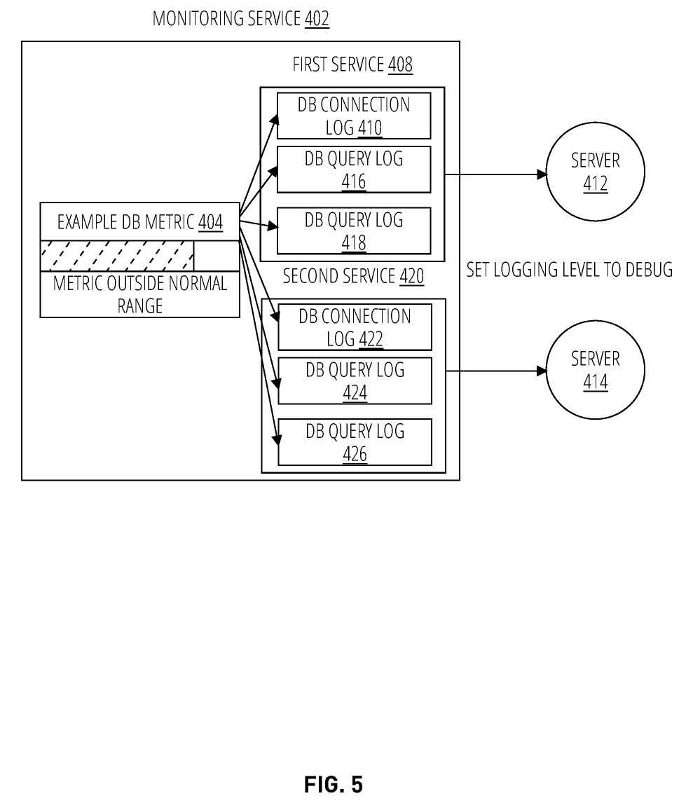

FIG. 4 illustrates the association between metrics 320 and the logs 322 residing within specific services according to an embodiment of the disclosure. Specifically, FIG. 4 and FIG. 5 show an association between an example database metric 404 and logs (database connection log 410, database query log 416, database query log 418, database connection log 422, database query log 424, database query log 426 of a first service 408 and a second service 420. The figures outline the process of adjusting log levels based on the state of a monitored metric. In FIG. 4, an example database metric 404 is shown operating within a normal range. A monitoring service 402, which may be standalone, or in some cases configured as the system reliability module 324 or a part thereof, may maintain the associated log levels at INFO, reflecting standard operations.

When the monitored metric remains within its normal operational range, the log level set at INFO may ensure that standard operational data is recorded without overwhelming the system with verbose logging. The level may capture key events, such as service start-ups, configuration changes, or routine interactions, which may be sufficient for routine monitoring and auditing. By maintaining logs at the INFO level during normal conditions, the system may avoid unnecessary storage consumption and processing overhead while still ensuring that essential operational data is readily available for review.

The INFO level may act as a baseline for monitoring and ensures that only significant events related to the general health of the system are logged. This reduces noise in log data, making it easier for system administrators or SREs to identify meaningful patterns during normal operations. In distributed environments, where services span multiple clusters or geographies, the use of INFO-level logging may also minimize the strain on log collection and aggregation pipelines, allowing efficient functioning without compromising on information capture.

As shown in FIG. 5, when the example database metric 404 surpasses a predetermined threshold, signaling an anomaly, the monitoring service 402 increases the verbosity of logs by setting logging level of logs associated with the metric to a DEBUG level. The increase allows more detailed information to be captured for retroactive analysis and may allow information that is important to identifying the root cause of an issue to be determined since unlike conventional methods, the capture of the detailed data is performed immediately upon a metric meeting a predetermined criteria without human intervention. The monitoring service determines the logs associated with the metric and communicates with agents deployed within the respective services. The agents may be configured to apply the log level adjustments specifically to the affected logs. In embodiments, there may be a many-to-many mapping or relationship between metrics, logs, and the services they are deployed in. The services 408, 420 may also be associated with different server (such as server 412 and server 414)

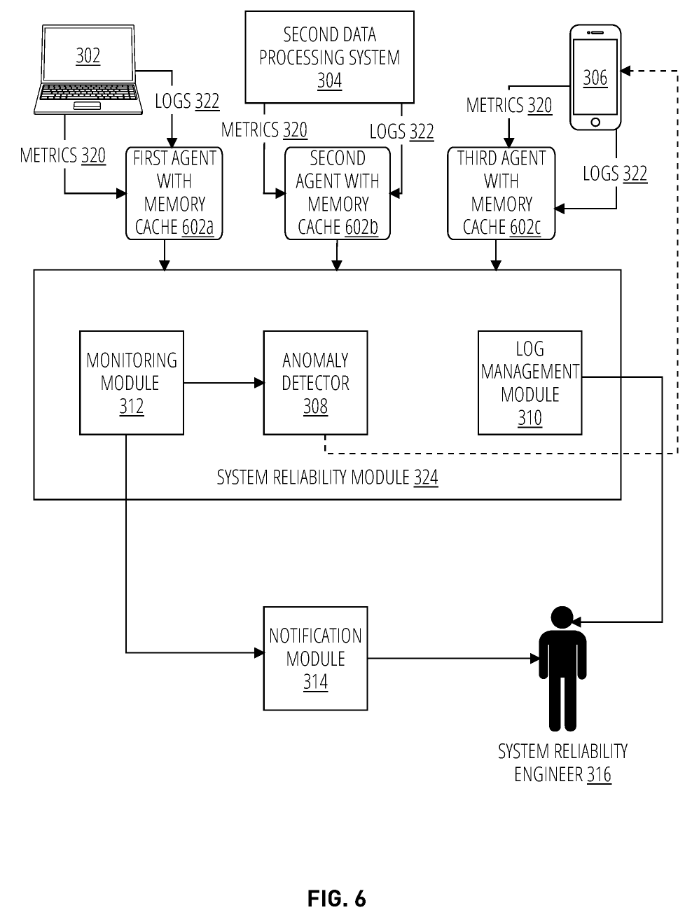

FIG. 6 illustrates an embodiment wherein the agent 318 comprises a memory cache. In the system of FIG. 6 a rolling cache of debugging logs or logging information for a predefined time window (e.g., the last 'x' minutes) is stored in the agents (for example first agent with memory cache 602a, second agent with memory cache 602b, and third agent with memory cache 602c. When a metric 320 meets a threshold criteria due to an unknown issue and triggers an anomaly by the anomaly detector 308, the cached logs may be retained for analysis providing the site reliability engineer 316 detailed retroactive logs with context, showing events leading up to the issue and potentially revealing a root cause.

The in-memory cache may also minimize the transmission of unnecessary logs, optimizing resource utilization. Once the affected metric returns to a normal state, the logging level may be returned to a lower value (such as INFO), and the cached logs of unaffected services may be discarded.

In an illustrative embodiment, the logs 322 and metrics 320 are linked through shared labels (such as operational contexts, or application-specific tags), which act as identifiers for their association. Optional service tags or identifiers further enhance the traceability of logs to their respective services, providing flexibility for scenarios where service-level tags may sub-optimal.

In further embodiments, request IDs may be used wherein responsive to a log 322 which has a logging level increased being of a request, all other logs that are a part of that request may be controlled to increase corresponding logging levels of all other logs. The other logs may be logs from any upstream and downstream services that have that request ID.

In further embodiments, the agents 318 and anomaly detector may be trained machine learning models. More specifically, the as agents 318 may not only be configured as intermediaries between applications and the monitoring service 402, enabling collection of logs from diverse applications without requiring individual applications to support metrics gathering natively, the agents may also integrate artificial intelligence for classifying metrics. Classifying metrics significantly eases the computational burden of setting relevant alerts. The agents 318 may be trained in a training phase during a normal operation of the application to, learning patterns, frequencies, and groupings of metrics. The training may define a baseline of 'normal' behavior. During training, the machine learning model (which may be a deep neural network) is configured to determine what frequency of all types of metrics are seen, which grouping of metric types are seen, and for each grouping, use pattern matching to determine what range of values are normal.

The training concludes when no new groupings emerge within a predefined timeframe. The agents then send metadata regarding the identified groupings along with raw metrics to the monitoring service, signaling the completion of agent training.

Once trained, the agents enter normal monitoring mode. The agents 318 continuously compare real-time metrics with the learned baseline to detect anomalies. If an agent encounters metrics that deviate significantly from the baseline, a warning is issued to the anomaly detector. Once the agents 318 are trained, then the anomaly detector 308 may also be trained by observing the meta-data about the groupings of available hybrid applications and using the metadata to learn the sequence that groups come in from applications. In an embodiment, a Recurrent Neural Network is used. The training may define is normal behavior, for example when one part of an application is processing data, the metrics 320 should show that another part of the application is updating its database due to the processing of the data. Once no new sequences are seen within a configurable timespan, the anomaly detector 308 may be considered trained and the entire data processing environment may return to normal monitoring. During normal monitoring, agents 318 may obtain meta-data about the groups including metrics 320. If any metrics 320 on the agent 318 do not readily fit into a categorized grouping, a warning is issued to the anomaly detector 308. In some cases, the warning may not cause an alert to trigger but may become a part of an alert. The trained anomaly detector then matches groupings to sequences to determine how much or how little the groupings match existing sequences. If a matching vector is too far away from any known sequences, an alert is then raised to site reliability engineers 316 further investigation. This alert should also contain any warnings seen since the start of a last sequence, which was the closest to the current alerting sequence, to help diagnose the alert.

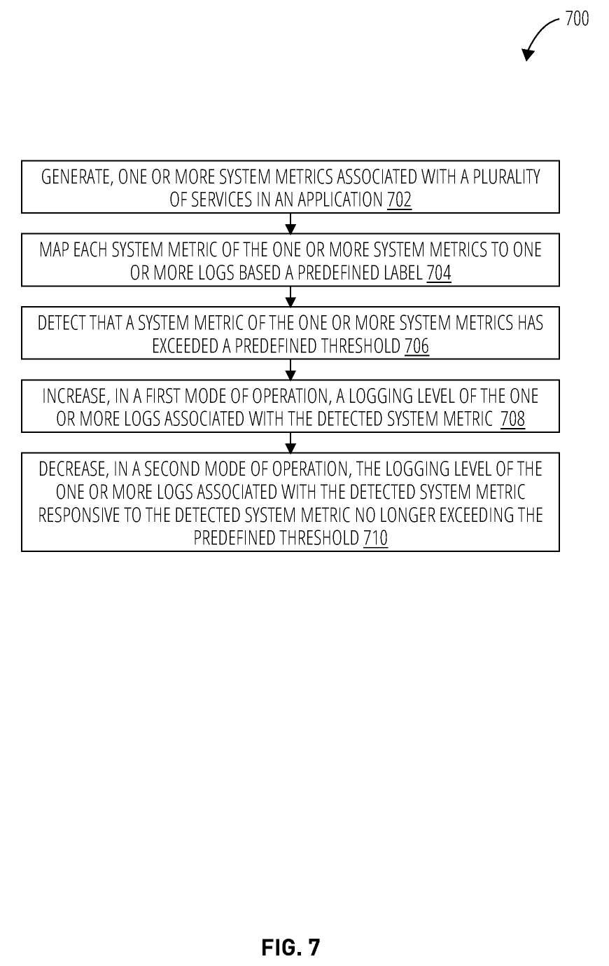

FIG. 7 illustrates a routine 700 for adjusting logging levels in a hybrid application according to an embodiment of the disclosure. The routine may be performed with the retroactive root cause analysis engine 126. The routine starts in block 702, the retroactive root cause analysis engine 126 generates, one or more system metrics associated with a plurality of services in an application. In block 704, the retroactive root cause analysis engine 126 maps each system metric of the one or more system metrics to one or more logs based on a predefined label. In block 706, the retroactive root cause analysis engine 126 detects that a system metric of the one or more system metrics has exceeded a predefined threshold. In block 708, the retroactive root cause analysis engine 126 increases, in a first mode of operation, a logging level of the one or more logs associated with the detected system metric. In block 710, the retroactive root cause analysis engine 126 decreases, in a second mode of operation, the logging level of the one or more logs associated with the detected system metric responsive to the detected system metric no longer exceeding the predefined threshold. In an embodiment, in normal operations, when metrics stay within acceptable thresholds, the system discards older logs that exceed a set storage limit, such that the most relevant data is retained.

In another embodiment, one or more agents includes an in-memory storage for temporarily storing logs.

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for adjusting logging levels comprising:
generating, one or more system metrics associated with a plurality of distributed services in an application;
mapping each system metric of the one or more system metrics to one or more logs based on a predefined label;
detecting that a system metric of the one or more system metrics has exceeded a predefined threshold;
increasing, in a first mode of operation, a logging level of the one or more logs associated with the detected system metric; and
decreasing, in a second mode of operation, the logging level of the one or more logs associated with the detected system metric responsive to the detected system metric no longer exceeding the predefined threshold,
wherein the one or more logs of the first mode of operation comprise more detail than the one or more logs of the second mode of operation.

2. The method of claim 1, wherein the mapping is a many-to-many mapping.

3. The method of claim 1, further comprising:
receiving by an agent, of any distributed service of the plurality of distributed services that has the one or more logs associated with the system metric, the one or more logs for further processing.

4. The method of claim 3, further comprising controlling, in the first mode, the agent to increase the logging level.

5. The method of claim 3, further comprising configuring the agent to store a rolling cache or a plurality of logging information.

6. The method of claim 5, wherein when the system metric is within the predefined threshold, the rolling cache or the plurality of logging information is discarded.

7. The method of claim 5, wherein when the system metric of the one or more system metrics exceeds the predefined threshold, the rolling cache or the plurality of logging information is transmitted, by the agent, to an anomaly detector.

8. The method of claim 7, wherein the anomaly detector is a machine learning model trained to detect when the rolling cache or the plurality of logging information from a plurality of agents follow a sequence indicative of an anomaly.

9. The method of claim 3, wherein the agent is a machine learning model trained to detect when the system metric exceeds the predefined threshold.

10. The method of claim 1, wherein the predefined label used for mapping the logs to the system metrics comprises at least one of service identifiers, operational contexts, and application-specific tags.

11. A computing device comprising:
a processor; and
a memory, in communication with the processor, with one or more computer program instructions stored on the memory, the computer program instructions, when executed by the processor, cause the computing device to perform operations comprising:
generating, one or more system metrics associated with a plurality of distributed services in an application;
mapping each system metric of the one or more system metrics to one or more logs based on a predefined label;
detecting that a system metric of the one or more system metrics has exceeded a predefined threshold;
increasing, in a first mode of operation, a logging level of the one or more logs associated with the detected system metric; and
decreasing, in a second mode of operation, the logging level of the one or more logs associated with the detected system metric responsive to the detected system metric no longer exceeding the predefined threshold,
wherein the one or more logs of the first mode of operation comprise more detail than the one or more logs of the second mode of operation.

12. The computing device of claim 11, wherein the mapping is a many-to-many mapping.

13. The computing device of claim 11, wherein the computer program instructions cause the computing device to further perform operations comprising receiving by an agent, of any distributed service of the plurality of distributed services that has the one or more logs associated with the system metric, the one or more logs for further processing.

14. The computing device of claim 13, wherein the computer program instructions further cause the computing device to further perform operations comprising controlling, in the first mode, the agent to increase the logging level.

15. The computing device of claim 13, wherein the computer program instructions further cause the computing device to further perform operations comprising configuring the agent to store a rolling cache or a plurality of logging information.

16. The computing device of claim 15, wherein:
when the system metric of the one or more system metrics exceeds the predefined threshold, the rolling cache or the plurality of logging information is transmitted, by the agent, to an anomaly detector, and
the anomaly detector is a machine learning model trained to detect when the rolling cache from a plurality of agents follow a sequence indicative of an anomaly.

17. The computing device of claim 13, wherein the agent is a machine learning model trained to detect when the system metric exceeds the predefined threshold.

18. A computer program product for adjusting logging levels in a hybrid application, the computer program product comprising:
one or more computer-readable storage devices and program instructions stored on the at least one of the one or more computer-readable storage devices, the program instructions executable by a processor, the program instructions comprising:
program instructions to generate, one or more system metrics associated with a plurality of distributed services in an application;
program instructions to map each system metric of the one or more system metrics to one or more logs based on a predefined label;
program instructions to detect that a system metric of the one or more system metrics has exceeded a predefined threshold;
program instructions to increase, in a first mode of operation, a logging level of the one or more logs associated with the detected system metric; and
program instructions to decrease, in a second mode of operation, the logging level of the one or more logs associated with the detected system metric responsive to the detected system metric no longer exceeding the predefined threshold,
wherein the one or more logs of the first mode of operation comprise more detail than the one or more logs of the second mode of operation.

19. The computer program product of claim 18, wherein the program instructions further comprise program instructions to receiving by an agent, of any distributed service of the plurality of distributed services that has the one or more logs associated with the system metric, the one or more logs for further processing.

20. The computer program product of claim 19, wherein the agent is a machine learning model trained to detect when the system metric exceeds the predefined threshold.
